(19) United States
(12) Patent Application Publication
(10) Pub. No.: US 2008/0229007 A1
(43) Pub. Date: Sep. 18, 2008

(54) Enhancements to an XDR Memory Controller to Allow for Conversion to DDR2

(76) Inventors: Mark D. Bellows, Rochester, MN (US); Paul A. Ganfield, Rochester, MN (US); Kent H. Haselhorst, Byron, MN (US); Ryan A. Heckendorf, Rochester, MN (US)

Correspondence Address: IBM CORPORATION, 3605 HIGHWAY 52 NORTH, DEPT. 917, ROCHESTER, MN, 55901-7829, US

(21) Appl. No.: 11/686,629

(22) Filed: Mar. 15, 2007

(51) Int. Cl. G06F 12/00

(52) U.S. Cl. 711/105

(57) ABSTRACT

A memory control apparatus includes a data stream format converter and a physical layer converter. The data stream format converter is configured to convert an incoming data stream that has a data stream format corresponding to a first memory type into a format-converted data stream that has a data stream format corresponding to a second memory type. The second memory type is different from the first memory type. The physical layer converter is configured to convert the format-converted data stream into a physical-layer-converted data stream that has at least one physical parameter corresponding to the second memory type. The format-converted data stream has at least one physical parameter corresponding to the first memory type.

### BACKGROUND OF THE INVENTION

1. Field of the Invention

The present invention relates to computer memory and, more specifically, to a memory controller that allows a system configured for use with a first type of memory to use a second type of memory.

2. Description of the Prior Art

Random access memory (RAM) is used by almost every type of computational system to store data. RAM stores all sorts of information used by the processor of the system, including instructions and the data being manipulated by the system. There are many different types of RAM, each having their own data transfer formats and set of physical parameters.

One type of RAM is double-data-rate-two synchronous dynamic random access memory (DDR2 SDRAM), which is a random access memory technology used for high speed storage of the working data of a computer or other digital electronic devices. It has the ability to run its data bus at twice the clock rate, thus enabling faster bus speeds and higher peak throughputs than earlier technologies.

Another type of RAM is XDR DRAM (extreme Data Rate dynamic RAM), which competes with DDR2 SDRAM. XDR DRAM was initially designed for small, high-bandwidth consumer systems, high-performance memory applications, and high-end processing units. It eliminates some of the high pin count problems found in other types of RAM. XDR memory systems provide high memory bandwidth by sending eight data bits per clock cycle over an XIO (extreme IO) link, from a memory controller to the XDR DRAMs. An XIO link is capable of achieving signal rates of 3.2 Gbps and above, allowing a memory controller to use fewer I/O pins and therefore save on die size and cost. However, XDR memory systems are currently limited in the amount of memory capacity they can support, whereas DDR2 systems can be expanded to use more memory than current XDR systems. XDR memory also tends to be more expensive than industry standard memories such as DDR2.

In some applications, highly functional processor chips (such as the Cell chip) that are originally configured for use with XDR memory could take advantage of certain properties of DDR2 memory (e.g., the lower cost of DDR2 memory and its greater expandability), except that DDR2 memory is not compatible with such processors. This is for two reasons: first, the data stream format of XDR memory is different from that of DDR2 memory (e.g., the number and timing of refreshes is different) and, second, the physical parameters of XDR memory are different from the physical parameters of DDR2 memory (e.g., they have different signal levels and different pin counts).

Therefore, there is a need for a method and apparatus that allows a system configured to use memory of a first type (such as XDR memory) to use memory of a second type (such as DDR2 memory).

### SUMMARY OF THE INVENTION

The disadvantages of the prior art are overcome by the present invention which, in one aspect, is a memory control apparatus that includes a data stream format converter and a physical layer converter. The data stream format converter is configured to convert an incoming data stream that has a data stream format corresponding to a first memory type into a format-converted data stream that has a data stream format corresponding to a second memory type. The second memory type is different from the first memory type. The physical layer converter is configured to convert the format-converted data stream into a physical-layer-converted data stream that has at least one physical parameter corresponding to the second memory type. The format-converted data stream has at least one physical parameter corresponding to the first memory type.

In another aspect, the invention is a memory controller for allowing a system to select between operating with XDR memory and operating with DDR2 memory. A data stream format converter is configured to receive an incoming XDR-format data stream from the system. The data stream format converter is also configured to insert periodically, into the XDR-format data stream, a DDR2 refresh sequence that has a periodicity corresponding to a pre-specified DDR2 refresh periodicity, thereby generating a DDR2-format data stream. A physical layer conversion chip is configured to convert each signal of the DDR2-format data stream into a corresponding signal having a signal level corresponding to pre-specified DDR2 signal levels. The physical layer conversion chip is also configured to match each signal of the DDR2-format data stream to a signal of a DDR2 memory channel.

In yet another aspect, the invention is a method of managing data in which a format of an incoming data stream from a data source that is configured to use a first type of memory is modified so as to generate a format-converted data stream that has a format corresponding to a second type of memory. The second type of memory is different from the first type of memory. At least one physical parameter of the format-converted data stream is adjusted so as to generate a physical-layer-converted data stream so that the physical-layer-converted data stream has at least one physical parameter that corresponds to the second type of memory.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a block diagram of an embodiment of a data converter for use with two different memory types.

FIG. 2 is a block diagram of a data converter that converts both the data stream format and physical parameters of the data stream.

FIG. 3 is a block diagram of an XDR memory-type system that is adapted to use DDR2 memory.

FIG. 4 is a block diagram that compares XDR memory-type operations to DDR2 memory-type operations.

FIG. 5 is a flow chart showing modification of data from a command queue.

FIGS. 6A-6B are data diagrams showing designation of memory address bits.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

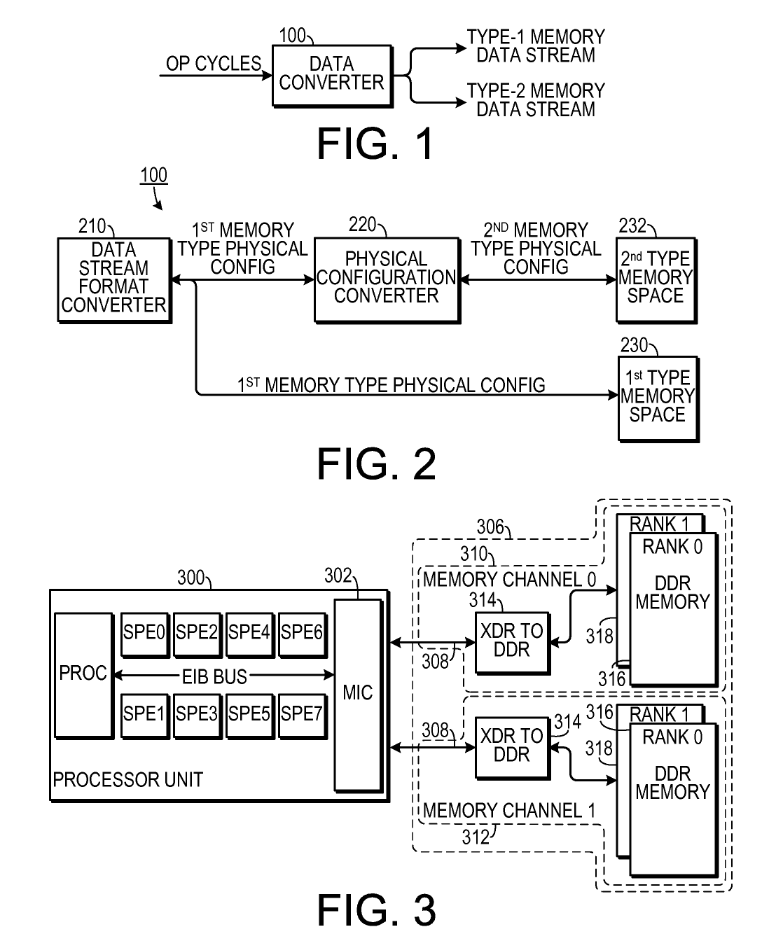

As discussed above, a typical computational system is configured to use a single type of memory. However, as shown in FIG. 1, a data converter 100 can be used to allow such a system to use a second type (or even several types) of memory. In such a system, a stream of operational cycles (OP Cycles) are modified by the data converter 100 to have both the data stream format and the physical characteristics of the type of memory that is being employed by the system.

In one embodiment, as shown in FIG. 2, the data converter 100 includes a data stream format converter 210, which could be implemented in software running on an existing processor, that formats that data stream coming from the system so as to be compatible with the memory type that the system is using. If the system is originally configured to use the first memory type and if the system is currently using memory of the first memory type, then the data stream format converter 210 configures the data stream for use with the first memory type and then the data stream is connected with memory space 230 of the first memory type.

On the other hand, if the system is originally configured to use the first memory type and if the system is currently using memory of the second memory type, then the data stream format converter 210 generates a data stream that has a format that is compatible with the second memory type. For example the data stream format converter 210 inserts refresh events according to a refresh schedule corresponding to the second memory type. The resulting format-converted data stream is sent to a physical configuration converter 220 that converts physical layer characteristics of the format-converted data stream so as to have physical characteristics that are compatible with the second memory type. The physical layer converter can convert such physical parameters of the incoming data stream as: the signal levels (e.g., voltage) of each signal, the number of signals required (if, for example, the memory of the first type has a different pin count from the memory of a second type), and the clock frequency corresponding to the signals. The resulting physical-layer-converted data stream is then sent to memory space 232 of the second memory type.

One illustrative embodiment, as shown in FIG. 3, allows a Cell processor unit 300 that is configured for use with XDR memory to use DDR2 memory. The Cell processor unit 300 includes a processor element (PROC) that schedules operations on a plurality of synergistic processor elements (SPE's), each of which communicating via an element interconnect bus (EIB BUS—also referred to as the “BE BUS”). The Cell processor unit 300 communicates with its associated memory space 306 via a memory controller 302. The memory controller 302 may be programmed to generate memory access cycles (including all necessary refresh events and memory rank change gaps) in either the XDR memory format or the DDR2 memory format.

The memory space 306 includes a first memory channel 310 and a second memory channel 312. The first memory channel 310 and the second memory channel 312 each communicate with the memory controller 302 via a separate memory channel address bus 308. Each memory channel 310 and 312 includes a physical layer converter 314 (which coverts XDR signal parameters to corresponding DDR2 signal parameters) and two ranks (a first rank 316 and a second rank 318) of DDR2 memory. (More ranks, or fewer, of DDR2 memory may be added, depending upon the specific application.)

The physical layer converters 314 of the specific embodiment shown in FIG. 3 correspond to the physical layer converter 220 of the more general embodiment shown in FIG. 2. Similarly, the memory ranks 316 and 318 in FIG. 3 correspond to the memory space 232 of the second memory type shown in FIG. 2. Also, the memory controller 302 shown in FIG. 3 performs the data stream formatting that is performed by the data stream format converter 210 shown in FIG. 2.

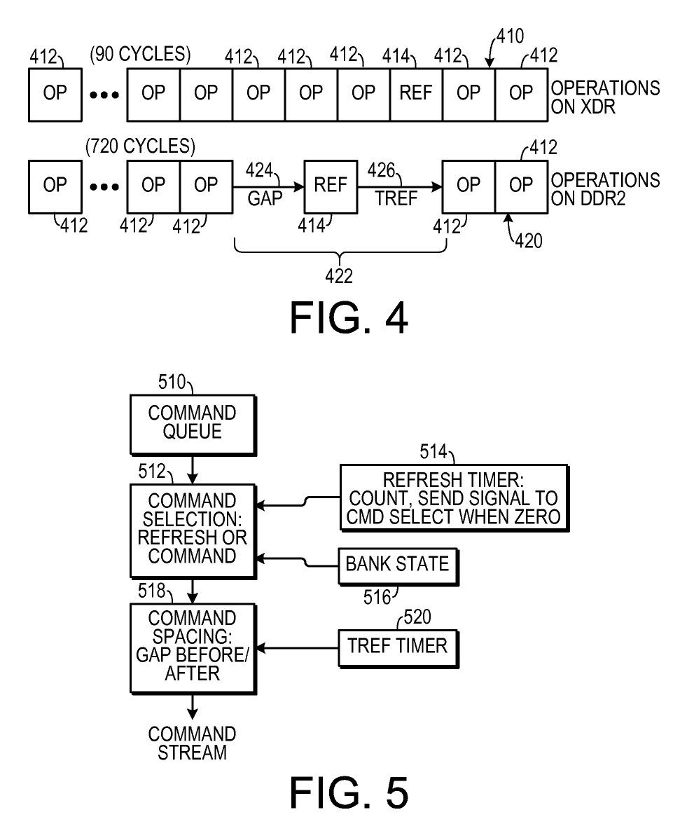

As shown in FIG. 4, a typical XDR-memory-based system data stream 410 will include a pattern that includes 90 cycles of operational cycles 412 and a refresh cycle 414. Each sequential refresh cycles 414 is directed to a different memory bank in the memory space. For example, after 90 operational cycles 412 a first refresh cycle 414 causes a refresh of a first bank of memory, after another 90 operational cycles 412 a second refresh cycle 414 causes a refresh of a second bank of memory, and so on. This continues until each bank of memory have been refreshed, at which the process is repeated.

The DDR2 data stream 420 employs a different refresh pattern. In a DDR2 system, all banks of all ranks of memory are refreshed in one refresh event 422. To facilitate a refresh event, a gap time delay 424 is added to the data stream prior to the refresh command 414 to allow any pending operations in the DDR2 memory space to complete. Then, after the refresh command 414, a refresh time delay period “tREF” 426 is inserted to allow all of the DDR2 memory ranks to complete the refresh. After the tREF time delay 426, ordinary operational cycles 412 are transmitted until the next refresh event 422 (which will typically happen after 720 operational cycles 412).

As shown in FIG. 5, a command queue 510 transmits a data stream to a command selector 512, which selects between either continued propagation of the data from the command queue 510 or the insertion of a refresh event into the data stream. The command selector 512 receives input from a refresh timer 514 that counts down the number of cycles between each refresh event. When the refresh timer 514 reaches zero, then it will assert a signal that causes the command selector 512 to insert a refresh event. Also, a bank state circuit 516 monitors the state of each memory bank so that the command selector 512 issues refresh events only when the selected refresh banks are ready. A command spacing circuit 518 then adds any necessary gap time delays or tREF time delays into the data stream. The tREF time delays are timed by a tREF timer 520.

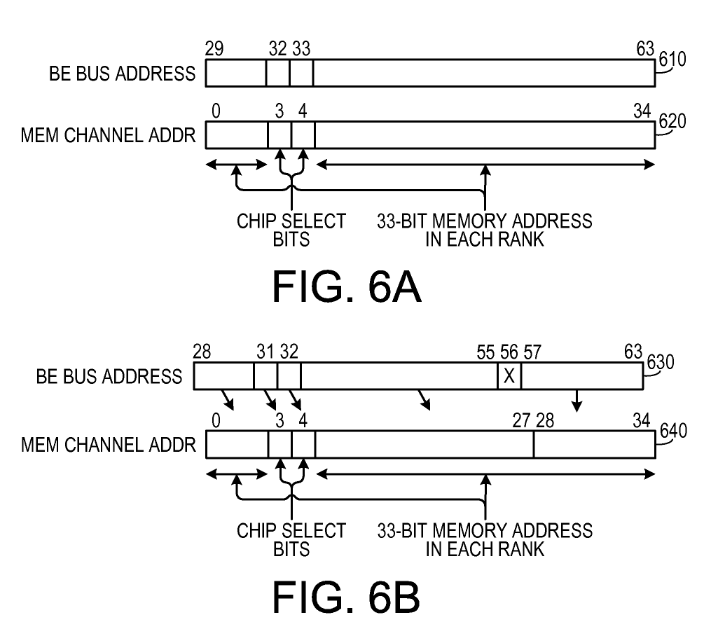

The relationship between addresses on the EIB Bus and corresponding addresses on the memory channel are shown in FIGS. 6A and 6B. As shown in FIG. 6A, if a single memory channel is used, the bits of the address on the EIB Bus 610 correspond directly to the address bits on the memory channel 620. Two bits (32 and 33 on the EIB Bus 610 and 3 and 4 on the memory channel 620) are designated as chip select bits when being used with DDR2 memory to signify which rank of memory is being used, but become normal address bits when used with XDR memory. If, when using DDR2 memory, the value of the chip select bits changes (e.g., from “00” to “01”), then the system is about to change the rank of memory that it is accessing. In such a situation, the system adds a gap in the data stream to allow any previous activities on the previous rank to complete prior to accessing the new rank.

An additional bit must be used when the system is employing a dual-channel memory space, as shown in FIG. 6B. In one embodiment, bit 56 of the EIB Bus 630 is used to indicate whether the first channel (in which case bit 56=“0”) or the second channel (in which case bit 56=“1”) is being selected for access. This bit is eliminated on the memory channel bus 640 as it is unnecessary once the memory channel has already been selected.

In order to use a chip with an XIO interface in an application which requires large amounts of memory, a bridge chip is required which converts the XDR command and data protocols to the DDR2 command and data protocols. This solution maintains the advantage of using the XIO link (fewer pins on the expensive memory controller), but enables the advantages of DDR2 (low cost, high capacity).

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A memory control apparatus, comprising:
a. a data stream format converter that is configured to convert an incoming data stream that has a data stream format corresponding to a first memory type into a format-converted data stream that has a data stream format corresponding to a second memory type, different from the first memory type; and
b. a physical layer converter that is configured to convert the format-converted data stream, that has at least one physical parameter corresponding to the first memory type, into a physical-layer-converted data stream that has at least one physical parameter corresponding to the second memory type.

2. The memory control apparatus of claim 1, wherein the data stream format converter is configured to receive the incoming data stream and insert refresh events according to a refresh schedule corresponding to the second memory type.

3. The memory control apparatus of claim 2, wherein the refresh events each include:
a. a gap time delay period;
b. a refresh command inserted after the gap time delay period; and
c. a refresh time delay period inserted after the refresh command.

4. The memory control apparatus of claim 1, wherein the data stream format converter is configured to:
a. detect when a first memory access is directed to a first memory rank and a subsequent second memory access is directed to a second memory rank, different from the first memory rank; and
b. insert a gap time delay period between the first memory access and the second memory access.

5. The memory control apparatus of claim 1, wherein the physical layer converter is configured to convert at least a first signal of the incoming data stream having a first level to a second signal having a second signal level, different from the first signal level.

6. The memory control apparatus of claim 1, wherein the format-converted data stream includes a first predetermined number of signals and wherein the physical layer converter is configured to generate the physical-layer-converted data stream so as to have a second predetermined number of signals, different from the first predetermined number of signals, so as to have data corresponding to the format-converted data stream.

7. The memory control apparatus of claim 1, wherein the first memory type comprises XDR memory and the second memory type comprises DDR2 memory.

8. A memory controller for allowing a system to select between operating with XDR memory and operating with DDR2 memory, comprising:
a. a data stream format converter that is configured to receive an incoming XDR-format data stream from the system and that is also configured to insert periodically, into the XDR-format data stream, a DDR2 refresh sequence that has a periodicity corresponding to a pre-specified DDR2 refresh periodicity, thereby generating a DDR2-format data stream; and
b. a physical layer conversion chip that is configured to convert each signal of the DDR2-format data stream into a corresponding signal having a signal level corresponding to pre-specified DDR2 signal levels and that is also configured to match each signal of the DDR2-format data stream to a signal of a DDR2 memory channel.

9. The memory controller of claim 8, wherein the refresh sequence includes:
a. a gap time delay period;
b. a refresh command inserted after the gap time delay period; and
c. a refresh time delay period inserted after the refresh command.

10. The memory control apparatus of claim 8, wherein the DDR2-format data stream includes a first predetermined number of signals and wherein the physical layer conversion chip is configured to generate a physical-layer-converted data stream so as to have a second predetermined number of signals, different from the first predetermined number of signals.

11. The memory control apparatus of claim 8, wherein the refresh events each include:
a. a gap time delay period;
b. a refresh command inserted after the gap time delay period; and
c. a refresh time delay period inserted after the refresh command.

12. The memory controller of claim 8, wherein the incoming XDR-format data stream is received from a EIB bus channel and wherein the memory controller is configured to communicate with a selected one of two memory channels.

13. The memory controller of claim 12, wherein the EIB bus channel includes a bit indicating which of the two memory channels is being communicated with.

14. A method of managing data, comprising the actions of:
a. modifying a format of an incoming data stream from a data source that is configured to use a first type of memory so as to generate a format-converted data stream that has a format corresponding to a second type of memory, different from the first type of memory; and
b. adjusting at least one physical parameter of the format-converted data stream so as to generate a physical-layer-converted data stream so that the physical-layer-converted data stream has at least one physical parameter that corresponds to the second type of memory.

15. The method of managing data of claim 14, wherein the first type of memory comprises XDR memory and wherein the second type of memory comprises DDR2 memory.

16. The method of managing data of claim 14, further comprising the actions of:
a. detecting when a first memory access is directed to a first memory rank and a subsequent second memory access is directed to a second memory rank, different from the first memory rank; and
b. inserting a gap time delay period between the first memory access and the second memory access.

17. The method of managing data of claim 14, wherein the modifying action comprises the actions of:
a. periodically inserting a gap time delay period into the data stream after a predetermined number of operational cycles have been executed since a previous refresh;
b. inserting a refresh command into the data stream after the gap time delay period expires; and
c. inserting a refresh time delay period after the refresh command has been inserted.

18. The method of managing data of claim 17, wherein the action of adjusting at least one physical parameter comprises converting a signal level of at least one signal from a first signal level corresponding to the incoming data stream to a second signal level corresponding to the second type of memory.

19. The method of managing data of claim 17, wherein the action of adjusting at least one physical parameter comprises converting a clock frequency of at least one signal from a first clock frequency corresponding to the incoming data stream to a second clock frequency corresponding to the second type of memory.

20. The method of managing data of claim 17, further comprising the action of selecting which of two memory channels to transmit data onto.
